(19) United States
(12) Patent Application Publication
(10) Pub. No.: US 2007/0176059 A1
(43) Pub. Date: Aug. 2, 2007

(54) Beam-column clamp

(76) Inventors: Robert Roscetti, Woodbridge (CA); Allan Mills, Bethany (CA); Robert McCrudden, Blackstock (CA); Vincenzo Gentile, Toronto (CA)

Correspondence Address: BERESKIN AND PARR, 40 KING STREET WEST, BOX 401, TORONTO, ON, M5H 3Y2, CA

(21) Appl. No.: 11/639,194

(22) Filed: Dec. 15, 2006

(30) Foreign Application Priority Data
Dec. 20, 2005 (CA) 2530902

(51) Int. Cl. F16M 11/00

(52) U.S. Cl. 248/122.1

(57) ABSTRACT

An apparatus for clamping a beam to a column is disclosed. The apparatus includes a base securable one end of the column, first and second clamping members movably connected to the base, and a rack-and-pinion assembly for moving the clamping members between a released position and a clamped position where the clamping members are clamped to the beam.

### FIELD OF THE INVENTION

This invention relates to building construction, and in particular, to a clamp for securing a beam to a column.

### BACKGROUND OF THE INVENTION

In the building construction process, it is typically necessary at some point to securely connect a beam to a column. One known beam to column connection, particularly useful for securing metal beams to metal columns, requires welding the beam to the column.

This prior art beam-column connection has numerous disadvantages. One of these disadvantages is that the use of welding equipment on construction sites creates a significant risk of fire. This in turn increases the cost of construction by increasing the cost of insurance.

Accordingly, there is a need for a beam column connection which does not require welding.

### SUMMARY OF THE INVENTION

The present invention provides an improved beam column clamp which permits a beam to be secured to a column without welding.

According to a first aspect of the invention, an apparatus for clamping a beam to a first end of a column is provided. The apparatus comprises a base securable to the first end of the column, first and second clamping members movably connected to the base, and a moving means for moving the clamping members between a released position and a clamped position where the clamping members are clamped to the beam.

According to a second aspect of the invention, an apparatus for clamping a beam to a first end of a column is provided. The apparatus comprises:
(i) a base defining a bore therein;
(ii) first and second clamping members movably connected to the base, wherein the first and second clamping members are movable between a released position and a clamped position where the clamping members are clamped to the beam;
(iii) first and second racks connected to the first and second clamping members, respectively;
(iv) first and second pinions rotatably connected to the base, wherein the first pinion engages the first rack and the second pinion engages the second rack; and
(v) a sprocket adapted for connection to the first end of the column, wherein the sprocket is adapted to pass through the bore and engage the first and second racks to secure the clamping members in the clamped position.

According to a third aspect of the invention, an apparatus for clamping a beam to a first end of a column is provided. The apparatus comprises a base securable to the first end of the column, first and second clamping members movably connected to the base, and a moving assembly for moving the clamping members between a released position and a clamped position where the clamping members are clamped to the beam.

### BRIEF DESCRIPTION OF THE DRAWINGS

In the accompanying drawings:

FIG. 1 is an exploded perspective view showing a preferred embodiment of the beam-column clamp according to the present invention;

FIG. 2 is a perspective view showing the preferred embodiment in the clamped position;

FIG. 3 is a partial cross-sectional view of the preferred embodiment;

FIG. 4 is a plan view of the preferred embodiment in the open position; and

FIG. 5 is a plan view of the preferred embodiment in the clamped position.

### DETAILED DESCRIPTION OF THE INVENTION

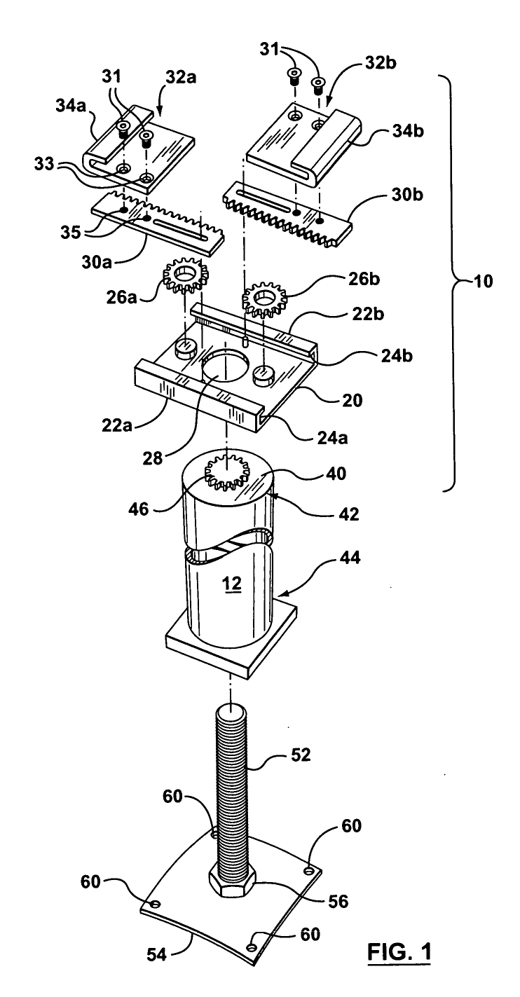

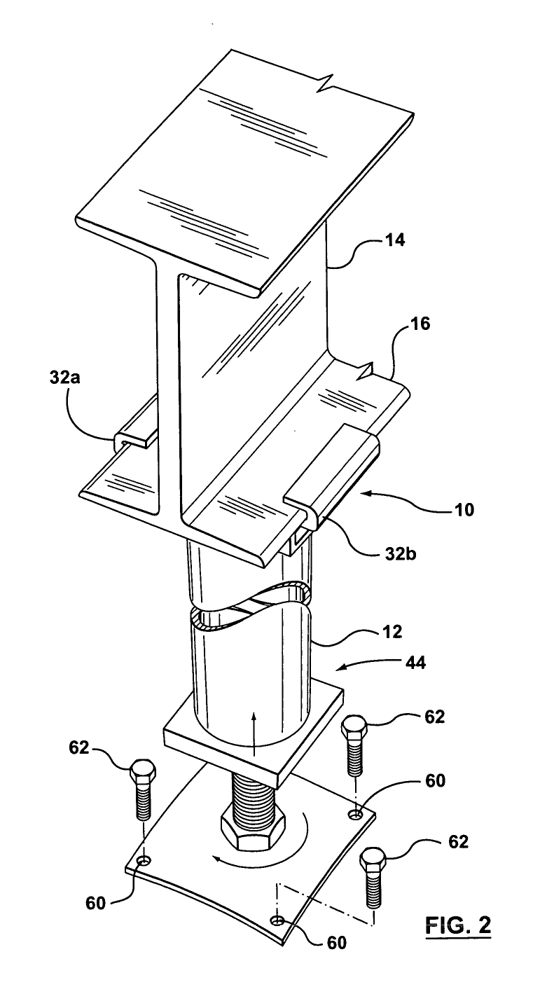

FIGS. 1 and 2 show a beam-column clamp apparatus 10 for connecting a column 12 to a beam 14, according to a preferred embodiment of the present invention. The column may have a first end, such as upper end 42, and second end, such as lower end 44. The beam-column clamp 10 is particularly suited for securing an I-beam or other beam having a flange 16 to the column 12, which preferably has a hollow cylindrical shape.

Referring to FIG. 1, the beam-column clamp 10 comprises a preferably rectangular base 20, which includes upwardly depending opposing sides 22a, 22b. A channel 24a, 24b is formed in each side 22a, 22b, respectively. Two spaced apart pinions 26a, 26b are rotatably connected to the base 20 in any suitable fashion. The base 20 includes a preferably circular central bore 28 located between the pinions 26a,b. Each pinion 26a, 26b engages a corresponding rack 30a, 30b, respectively, for sliding movement of the racks within the channels 24a, 24b. Each rack 30a, 30b is connected to a corresponding clamping member 32a, 32b which has a hook-shaped distal portion 34 to securely engage the lower flange 16 of the beam 14 (shown in FIG. 2). Each clamping member 32a, 32b is secured to the corresponding rack 30a, 30b in any suitable fashion, such as by threaded fasteners 31 received in threaded openings 33 in the clamping members 32a, 32b and threaded openings 35 in the racks 30a, 30b.

Continuing to refer to FIG. 1, the beam-column clamp 10 includes a circular column plate 40 fitted within the inside diameter of the upper end 42 of the column 12 in any suitable fashion. A locking member, such as a sprocket 46, is secured to the column plate 40 in any suitable fashion, such as by welding or fasteners. The sprocket 46 is sized to pass through the circular bore 28 and engage the pinions 26a, 26b.

It will be understood by those skilled in the art that the sprocket 46 may be secured to the upper end 42 of column 12 in any suitable fashion. For example, the column plate may have any shape, such as a rectangle. The rectangular column plate may rest on top of the column 12 and be secured to the column by welding.

Referring to FIGS. 1, 2 and 3, the lower end 44 of the column 12 includes a threaded opening 50 which receives an upper end of a threaded adjustment rod 52. The lower end of the adjustment rod 52 is connected to a foot plate 54. An adjustment nut 56 is secured to the adjustment rod 52.

The foot plate 54 has a plurality of holes 60 to receive fasteners 62 to secure the foot plate 54 to a surface, such as a foundation 70. Preferably, the foot plate 54 has a curved or “dished” surface.

The operation of the preferred embodiment of the present invention will now be described.

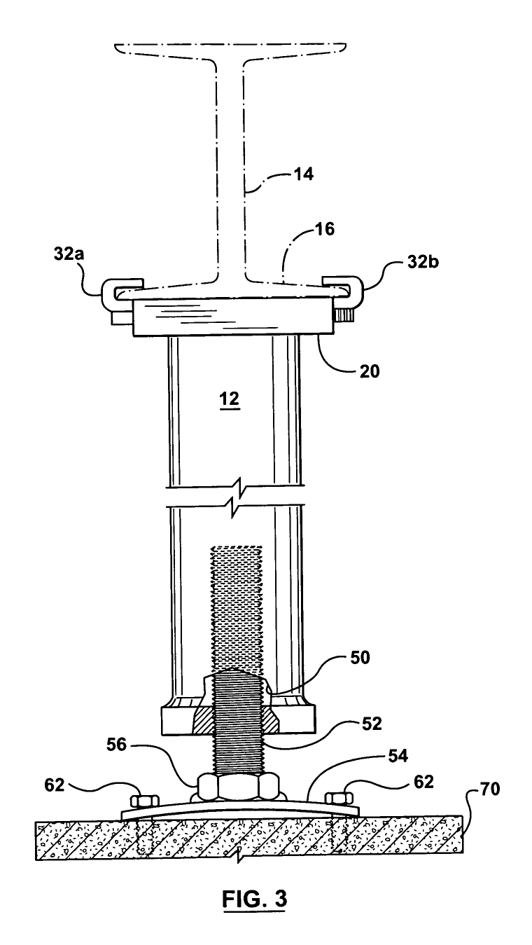

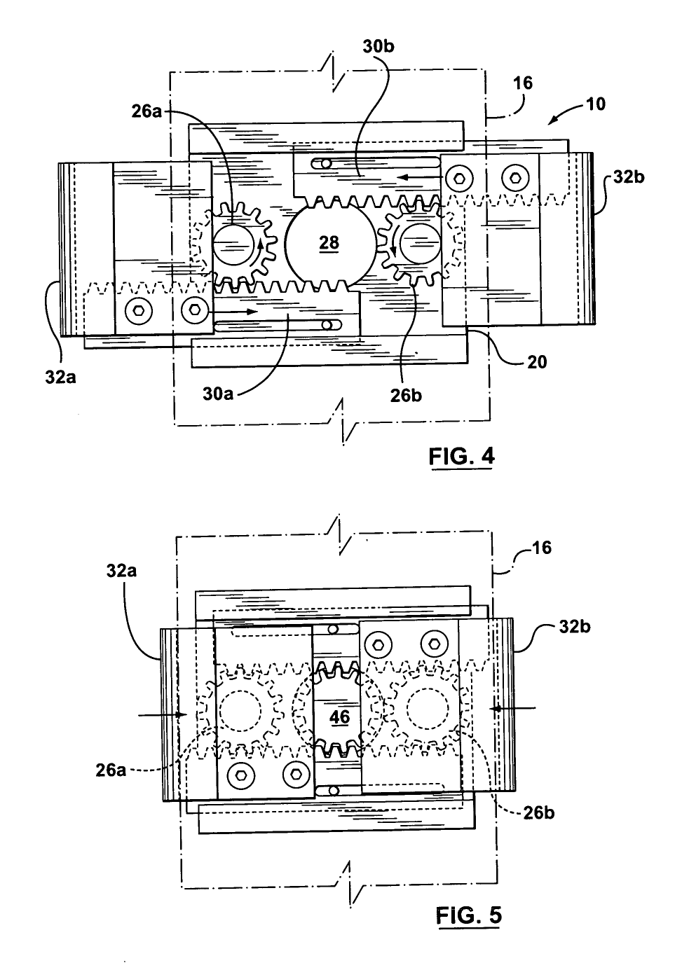

Referring to FIGS. 3 and 4, the base 20 of the beam-column clamp 10 is positioned below the lower flange 16 of the beam 14. The clamping members 32a, 32b are moved into the open position (shown in FIG. 4). The clamping members 32a, 32b are then pushed together into the clamped position, such that they engage the flange 16 of the beam 14. This clamped position is best shown in FIGS. 2, 3, and 5.

Referring now to FIG. 4, the inward movement of the clamping members 32a, 32b causes the corresponding racks 30a, 30b to move inward and the corresponding pinions 26a, 26b to rotate.

Referring now to FIGS. 1 and 5, the column 12 is then positioned under the base 20 such that the circular bore 28 is lined up with the sprocket 46. The column 12 is raised such that the sprocket 46 passes through the circular bore 28 and engages the pinions 26a, 26b. Because the sprocket 46 is fixed in relation to the column plate 40, the pinions 26a, 26b can no longer rotate without the column 12 also rotating.

Referring now to FIGS. 1-3, the threaded rod 52 is then turned using the nut 56 until the foot plate 54 is in contact with the foundation 70. The fasteners 62 are then used to secure the foot plate 54 to the foundation 70.

Securing the foot plate 54 to the foundation 70 causes the clamping members 32a, 32b to be locked in the clamped position. Specifically, the threaded rod 52 is prevented from rotating because it is secured to the foundation 70 at its lower end. The column 12 is prevented from rotating relative to the threaded rod 52, because to do so would require the column 12 to move vertically. The column 12 is prevented from moving vertically because it is secured to the beam 14 at its upper end 42 by the clamping members 32a, 32b. Consequently, the sprocket 46 is prevented from rotating, thereby restricting the clamping members 32a, 32b from moving out of the clamped position.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. An apparatus for clamping a beam to a first end of a column, the column having a second end securable to a surface, the apparatus comprising:
a) a base adapted to be secured to the first end of the column;
b) a first clamping member and a second clamping member, wherein the first and second clamping members are movably connected to the base, wherein the first and second clamping members are movable between a released position and a clamped position where the first and second members are clamped onto the beam; and
c) a moving means for moving the clamping members between the released and clamped positions.

2. The apparatus of claim 1, further comprising a locking member adapted for connection to the first end of the column, wherein the locking member is adapted to lock the first and second clamping members in the clamped position.

3. The apparatus of claim 2, wherein the base defines a bore therein, wherein the locking member is adapted to pass through the bore and engage the moving means, wherein the locking member is adapted to lock the first and second clamping member in the clamped position upon engagement with the moving means.

4. The apparatus of claim 3, wherein the moving means comprises:
a) a first rack connected to the first clamping member and a second rack connected to the second clamping member; and
b) a first pinion rotatably connected to the base and a second pinion rotatably connected to the base,
wherein the first pinion engages the first rack and the second pinion engages the second rack for sliding movement of the first and second racks.

5. The apparatus of claim 4, wherein the base comprises a pair of upwardly depending opposing sides, wherein each of the sides defines a channel therein, wherein each of the first and second rack is slidably received in a corresponding one of the pair of channels.

6. The apparatus of claim 4, wherein the locking member comprises a sprocket secured to the first end of the column, wherein the sprocket is adapted to pass through the bore and engage the first and second racks to secure the clamping members in the clamped position.

7. The apparatus of claim 6, wherein the first and second clamping members each comprise a hook-shaped distal portion.

8. The apparatus of claim 6, further comprising:
a) a threaded rod received in a threaded opening defined in the second end of the column; and
b) a foot plate connected to a lower end of the threaded rod, wherein the foot plate is adapted for being secured to the surface;
wherein the threaded rod is rotatable to bring the foot plate in contact with the surface.

9. The apparatus of claim 8, further comprising a nut secured to the threaded rod, wherein the threaded rod is rotated by turning the nut.

10. An apparatus for clamping a beam to a first end of a column, the column having a second end securable to a surface, the apparatus comprising:
a) a base defining a bore therein;
b) a first clamping member and a second clamping member, the first and second clamping members being movably connected to the base, wherein the first and second clamping members are movable between a released position and a clamped position where the clamping members are clamped onto the beam;
c) a first rack connected to the first clamping member and a second rack connected to the second clamping member;
d) a first pinion rotatably connected to the base and a second pinion rotatably connected to the base, wherein the first pinion engages the first rack and the second pinion engages the second rack for sliding movement of the first and second racks; and
e) a sprocket adapted for connection to the first end of the column, wherein the sprocket is adapted to pass through the bore and engage the first and second racks to secure the clamping members in the clamped position.

11. The apparatus of claim 10, wherein the base comprises a pair of upwardly depending opposing sides, wherein each of the sides defines a channel therein, wherein each of the first and second rack is slidably received in a corresponding one of the pair of channels.

12. The apparatus of claim 10, wherein the first and second clamping members each comprise a hook-shaped distal portion.

13. The apparatus of claim 10, further comprising:
a) a threaded rod received in a threaded opening defined in the second end of the column; and
b) a foot plate connected to a lower end of the threaded rod, wherein the foot plate is adapted for being secured to the surface;
wherein the threaded rod is rotatable to bring the foot plate in contact with the surface.

14. The apparatus of claim 13, further comprising a nut secured to the threaded rod, wherein the threaded rod is rotated by turning the nut.

15. An apparatus for clamping a beam to a first end of a column, the column having a second end securable to a surface, the apparatus comprising:
a) a base adapted to be secured to the first end of the column;
b) a first clamping member and a second clamping member, wherein the first and second clamping members are movably connected to the base, wherein the first and second clamping members are movable between a released position and a clamped position where the first and second members are clamped onto the beam; and
c) a moving assembly for moving the clamping members between the released and clamped positions.

16. The apparatus of claim 15, wherein the moving assembly comprises:
a) a first rack connected to the first clamping member and a second rack connected to the second clamping member; and
b) a first pinion rotatably connected to the base and a second pinion rotatably connected to the base,
wherein the first pinion engages the first rack and the second pinion engages the second rack for sliding movement of the first and second racks.

17. The apparatus of claim 16, further comprising a sprocket secured to the first end of the column, wherein the sprocket is adapted to pass through a bore defined in the base and engage the first and second racks to secure the clamping members in the clamped position.

18. The apparatus of claim 17, further comprising:
a) a threaded rod received in a threaded opening defined in the second end of the column; and
b) a foot plate connected to a lower end of the threaded rod, wherein the foot plate is adapted for being secured to the surface;
wherein the threaded rod is rotatable to bring the foot plate in contact with the surface.

19. The apparatus of claim 18, further comprising a nut secured to the threaded rod, wherein the threaded rod is rotated by turning the nut.
